(19) United States
(12) Patent Application Publication
(10) Pub. No.: US 2026/0273838 A1
(43) Pub. Date: Sep. 17, 2026

(54) DEVICE, METHOD AND SYSTEM FOR DRAWING A LINER INTO A TUBE BY MEANS OF AN INVERSION METHOD

(71) Applicant: BRAWO SYSTEMS GmbH, Kaiserslautern (DE)

(72) Inventors: Maximilian Fritz, Rutsweiler an der Lauter (DE); Christopher Schmitt, Otterbach (DE)

(21) Appl. No.: 19/162,403

(22) PCT Filed: Feb. 27, 2024
(86) PCT No.: PCT/EP2024/054965

§ 371 Date: Sep. 5, 2025

(30) Foreign Application Priority Data
Mar. 27, 2023 (DE) 10 2023 107 667.1

(51) Int. Cl. B29C 63/36; B29L 23/00

(52) U.S. Cl. CPC B29C 63/36; B29L 2023/006

(57) ABSTRACT

The invention relates to a device (300) for drawing a liner (20) into a tube (10) by means of an inversion method, comprising a pressure container (310) which can be applied with a pressure for inverting the liner (20); a shaft (320) that is rotatably mounted in an interior (312) of the pressure container (310) and has a rotatably mounted end (322) and a free end (324), wherein the shaft (320) is designed to unwind the liner (20) for inversion; and a first limiting element (330) arranged at the free end (324) of the shaft (320) and decoupled from a rotational movement of the shaft (320), wherein the first limiting element (330) is designed to limit a movement of the liner (20) in a direction parallel to an axis of rotation (DA) of the shaft (320), wherein the pressure container (310) comprises a supply access (340) for at least one curing device (100) that can be connected to a first end (22) of the liner (20).

The present disclosure relates to a device for drawing a liner into a tube by means of an inversion method and to a method and a system for drawing a liner into a tube by means of an inversion method. The present disclosure relates, in particular, to a simplified inversion method which can be carried out without interruption, in particular without a pressure drop or a pressure interruption.

### PRIOR ART

Tubes, e.g. for waste water canalization, can be repaired by drawing a flexible tubular liner with a resin-impregnated inner side into the tube by means of an inversion method. In this inversion method, air or water is introduced into the interior of the liner, as a result of which the liner comes to rest progressively on the inner wall of the tube. To subject the interior of the liner to pressure, one end of the liner can be secured on an air or water supply device. The other end of the liner, which is drawn into the tube, can be closed, e.g. with a knot, a closure cap or an adhesive bond. The closed end of the liner moves into the tube during the progressive inversion of the liner. During introduction into the tube, the liner is inverted, i.e. after introduction into the tube, the outer side of the liner is the inner side of the liner.

After the liner has been drawn in, the resin or curable coating of the liner is cured by means of heat and/or UV light to ensure that the liner bonds firmly to the tube and thus reseals the possibly leaky tube. For this purpose, a curing head, which is connected to the closed end of the liner, can be drawn into the tube together with the liner. Here, the curing head can be connected to the closed end of the liner after half of the inversion process, or is drawn into the tube after half of the inversion process. In particular, half of the liner has already been drawn into the tube at this point in time. To describe this in other words, one end of the liner is secured on the outlet of a pressure vessel or a drum, and the rest of the liner is wound onto the drum. When the interior of the drum is then subjected to pressure, the wound-up liner is inverted into the tube and then rests against the inner side of the tube. That is to say: when the closed end of the liner leaves the drum, this closed end of the liner moves further into the tube, with the result that the closed end of the liner is at the remote end of the tube at the end of the introduction process or inversion process.

To connect the curing head to the closed end of the liner, the inversion process must usually be interrupted. For this purpose, a lock situated between the drum and the tube is closed, thus enabling the pressure in the liner to be maintained. Air is then admitted to the drum, and the curing head can be fed in via an access at the lock and connected to the closed end of the liner. After connection of the curing head to the closed end of the liner, the lock is closed, and the drum can once again be subjected to pressure, and the liner is forced or introduced further into the tube and takes along the curing head connected to the closed end of the liner. Owing to the pressure drop in the drum for coupling the curing head, the liner may collapse on itself.

In another conventional solution, in which no lock is used between the drum and the liner, the pressure must also be released in the liner in order to couple the curing device to the liner.

After the liner and the curing head have been drawn into the tube, the connection between the curing head and the liner can be released, and the curing head is drawn back to the entry of the tube by means of a pulling cable or pulling cord while heat and/or light are emitted in order to cure the resin during this process.

The stopping of the inversion process after the halfway point, in particular, in order to connect the curing head to the closed end of the liner is time-consuming and represents a potential source of faults. Moreover, there is a need for a separate lock, as a result of which the size of the device is increased, and use in confined environments is made more difficult.

### DISCLOSURE OF THE INVENTION

It is an object of the present disclosure to specify a device for drawing a liner into a tube by means of an inversion method and a method for drawing a liner into a tube by means of an inversion method which enable an inversion process without interruption. In particular, it is an object of the present disclosure to reduce the size of a device for drawing a liner into a tube by means of an inversion method and to improve the handling of the system.

This object is achieved by the subject matter of the independent claims. Advantageous refinements are specified in the dependent claims.

According to an independent aspect of the present disclosure, a device for drawing a liner into a tube by means of an inversion method is indicated. The device comprises a pressure vessel, which can be subjected to a pressure to invert the liner; a shaft, which is rotatably supported in an interior of the pressure vessel and has a rotatably supported end and a free end, wherein the shaft is designed to unroll the liner for inversion; and a first limiting element, which is arranged at the free end of the shaft and is decoupled from a rotational movement of the shaft, wherein the first limiting element is designed to limit a movement of the liner in a direction parallel to an axis of rotation of the shaft, wherein the pressure vessel comprises a supply access.

The supply access is preferably arranged in a lateral vessel wall which lies opposite the free end of the rotatable shaft and/or the first limiting element.

In a second embodiment, the supply access can be arranged in the vessel wall or in the circumferential surface of the pressure vessel which is adjacent to the lateral vessel wall that lies opposite the free end of the rotatable shaft. In this case, the supply axis then lies opposite the outlet opening, wherein the shaft is arranged in between.

The supply access can be arranged in the circumferential region of the pressure vessel or in the vessel wall opposite the free end of the shaft. That is to say that the supply access opens into the free space between the first limiting element and the lateral vessel wall.

While feeding in the curing device both via a supply access in the circumferential surface of the pressure vessel and in the vessel wall, opposite the free end of the shaft, the flexible connecting element is guided to the liner from the side, that is to say through the first limiting element, thus ensuring that it cannot become knotted or entangled. This supply access in the circumferential surface of the pressure vessel is preferably arranged between the first limiting element and the lateral vessel wall of the pressure vessel, i.e. in and above the free space between the first limiting element and the lateral vessel wall of the pressure vessel.

In the second embodiment, the supply access therefore does not lie in the region of the lateral vessel wall, which lies substantially transversely to the axis of rotation of the shaft.

The supply access is provided in order to draw at least one curing device connectable to a first end of the liner into the pressure vessel and into the liner.

A spacing between the free end of the shaft and the lateral vessel wall is preferably provided in order to ensure that a connecting element is guided past the free end of the shaft or to ensure that the connecting element can be guided through the first limiting element to the liner and coupled to the latter. Thus, the first limiting element can rotate freely or in a manner decoupled from the shaft within the pressure vessel. At the same time, the spacing between the axis of rotation of the shaft and the vessel wall can additionally be greater than the spacing between the vessel wall and a circumference of the first limiting element.

The opening of the supply access in the vessel wall can be matched to the size of one curing head of the curing device in order to guide or introduce the curing head through the supply access into the pressure vessel or into the liner.

The supply access is preferably arranged in the lateral vessel wall between the outlet opening and the shaft axis.

The supply access preferably has an opening which is larger than the diameter of the shaft.

The opening of the supply access is preferably smaller than or at most equal to the size of the outlet opening.

If the supply access is arranged in the circumferential surface of the pressure vessel, the opening can be laterally offset or at least in partial overlap with respect to an inner opening of the outlet opening.

The inner opening of the outlet opening can be larger than an outer opening of the outlet opening. The vessel wall preferably tapers conically from the inner opening of the outlet opening to the outer opening of the outlet opening.

The inner opening of the outlet opening can be arranged in such a way that the liner can be guided into the inner opening of the outlet opening as it is unwound from the shaft. The inner opening of the outlet opening preferably substantially completely overlaps one region of the shaft.

The opening of the supply access is preferably offset with respect to a cross section of the shaft. The term “inversion method” as used in the context of the present disclosure denotes a method in which a flexible tubular or hose-shaped liner is drawn with a, for example, resin-impregnated inner side into a tube. For this purpose, a medium such as air or water is introduced into the interior of the liner, as a result of which the liner comes to rest progressively on the inner wall of the tube. To enable the interior of the liner to be subjected to pressure, one end of the liner is secured on an air or water supply device. The other end of the liner, which is drawn into the tube, is closed. During the progressive inversion of the liner, the closed end moves into the tube in order to line the inner wall of the tube, wherein the resin-impregnated inner side of the liner rests against the inner wall of the tube after being drawn in and inverted.

The method, described in the above section (prior art), for blowing the liner into the tube is also used in principle in the device and the method according to the invention. However, there are at least the following differences. The pressure vessel has a supply access for the curing device. In this case, the supply access can be closed in a pressure-tight manner. A limiting element is supported in a freely rotating manner within the pressure vessel on the end of the shaft which is situated on the same side as the supply access. The inversion process can be carried out without pressure interruption. In this case, the pressure can be maintained until the liner has cured and/or can no longer collapse.

The device is preferably designed to enable the at least one curing device to be connected to the first end of the liner in the interior of the pressure vessel before a beginning of the inversion. The inversion process can therefore be carried out without interruption. In particular, it is not necessary to interrupt the inversion process after the halfway point in order to connect the curing device to the first or closed end of the liner. Moreover, a lock for connecting the curing device after the halfway point of the inversion process can be omitted, thereby making it possible to reduce the size of the device.

The first limiting element is preferably decoupled from the rotational movement of the shaft in order to prevent a flexible connecting element, which connects the at least one curing device to the first end of the liner, from being wound onto the shaft and/or the first limiting element. In this case, a spacing is provided between the first limiting element or the free end of the shaft in order to guide the flexible connecting element between the first limiting element of the vessel wall so as to prevent entanglement or winding-up of the flexible connecting element. In other words, the structure of the device avoids a situation where the curing device, the supply thereof etc. interferes with the unrolling mechanism of the liner and gets stuck or bent on projections or edges. The inversion process can therefore be carried out without interruption. In particular, it is not necessary to interrupt the inversion process after the halfway point in order to connect the curing device to the first or closed end of the liner. Moreover, a lock for connecting the curing device after the halfway point of the inversion process can be omitted, thereby making it possible to reduce the size of the device.

In some embodiments, the flexible connecting element can be a cord.

The device is preferably designed to subject the pressure vessel to the pressure continuously from a beginning of the inversion to an end of the inversion. In other words, the inversion process can be carried out without intermediate air admission to the pressure region.

The tube is preferably a tube to be repaired or a channel to be repaired, e.g. a wastewater channel. However, the present disclosure is not restricted thereto, and the tube can be any tube into which a liner can be introduced for the purpose of reinforcement and/or repair.

The liner consists of a flexible material, e.g. corrosion-resistant synthetic and/or glass fibers.

The liner is prepared with a curable material which rests against the inner wall of the tube after being drawn in and inverted. The curable material can be a resin, for example. In some embodiments, the curable material can be cured by irradiating the curable material with energy, e.g. thermal energy or light, in particular UV light.

The supply access is preferably designed for a power supply and/or compressed air supply to the at least one curing device. In particular, at least one supply line can be passed through the supply access in order to supply the at least one curing device with energy from an external power source and/or compressed air. This supply line can be configured as a pulling cable or as a compressed air hose with a cable for power supply. After the decoupling from the closed end of the liner, the curing device is drawn back by means of the pulling cable or of the compressed air hose. During the curing process, the curing device can be cooled by means of the compressed air.

A hand wheel is preferably arranged outside the pressure vessel, this hand wheel being connected to the shaft, in particular being connected on the supported side of the shaft, in order to control winding or unwinding of the liner.

A holding cord is preferably secured on the closed end of the liner, this holding cord also being wound onto the shaft and being drawn simultaneously into the tube as the liner is drawn into the tube. The holding cord serves to prevent uncontrolled drawing-in of the liner. This can occur particularly when the liner has been drawn halfway into the tube. By moving the shaft by way of the hand wheel, it is possible to control the speed with which the liner is drawn into the tube. For this purpose, the holding cord can be wound first onto the shaft, and is connected or coupled to the closed end of the liner. In this case, the holding cord has at least the same length as the liner.

The first limiting element is preferably secured in a freely rotating manner on the free end of the shaft. For example, the first limiting element can be supported on the free end of the shaft by means of a rotary bearing, thus ensuring that the first limiting element is decoupled from the rotational movement of the shaft. As a result, the first limiting element can remain stationary in the event of contact with the at least one supply line of the at least one curing device during the inversion process, thus enabling the inversion process to be continued without impairment.

The first limiting element preferably comprises an aperture, through which the at least one curing device can be guided in order to be drawn into the tube with the first end of the liner. In particular, the at least one supply line can extend through the aperture during the inversion process. Since the first limiting element is decoupled from the rotational movement of the shaft, the first limiting element can remain stationary during the inversion process, thus enabling the inversion process to be continued without impairment. Here, the aperture is large enough to enable the curing head and the supply line of the curing device to be guided through the aperture.

In some embodiments, the aperture is a hole or a passage in the first limiting element. For example, the first limiting element can be a wheel or a circular disk, and the aperture can be present between two spokes of the wheel and can be configured as a circular segment, for example. In other words, the at least one supply line can extend through between the two spokes during the inversion process.

The first limiting element preferably comprises (or is) a disk and/or a wheel. In particular, the first limiting element can be a limiting disk.

The device preferably further comprises a second limiting element, which is arranged on the supported end of the shaft, wherein the second limiting element is designed to limit a movement of the liner in a direction parallel to the axis of rotation of the shaft. In particular, the first limiting element and the second limiting element can be spaced apart from one another, wherein the shaft extends from the first limiting element to the second limiting element. In the space thus provided between the first limiting element and the second limiting element, the liner can be wound onto the shaft before the beginning of the inversion process and can be unrolled from the shaft during the inversion process.

In some embodiments, the second limiting element can be connected rigidly to the shaft. In other words, the second limiting element can be coupled to the rotational movement of the shaft and rotate along with the shaft during the unrolling of the liner.

In some embodiments, the second limiting element comprises (or is) a disk and/or a wheel. In particular, the second limiting element can be a limiting disk.

The shaft, the first limiting element and the second limiting element preferably form a drum reel. The at least one curing device is designed to emit energy for curing the liner drawn into the tube, e.g. heat or light, in particular UV light. Typically, the at least one curing device comprises one or more LEDs.

The at least one curing device and/or the supply line can be fitted with one or more cameras in order to record the liner upstream and/or downstream of the curing device and to transfer the image information via the supply line to a control unit for display.

A plurality of curing devices, e.g. a plurality of LEDs, are preferably arranged concentrically on a cylindrical curing head. Irradiation in a manner that covers the entire surface of the inner side of the tube is thereby made possible. To cool the LEDs, compressed air can be fed in via the supply line.

The at least one curing device is preferably connected by means of a coupling to the first end of the liner (closed end). The coupling can be released electrically or pneumatically, for example, after the liner has been drawn into the tube, thus enabling the curing device to be drawn out of the tube while emitting energy for curing the liner.

After the curing device has been drawn out of the tube, the closed end of the liner can be cut open from the other side of the tube, for example. It is also possible to cut open the closed end of the liner by means of a milling device in order to reopen the tube. The milling device can be inserted subsequently into the cured liner.

According to another independent aspect of the present disclosure, a device for drawing a liner into a tube by means of an inversion method is indicated. The device comprises a pressure vessel, which can be subjected to a pressure to invert the liner; a shaft, which is rotatably supported in an interior of the pressure vessel; and a first limiting element for the liner, which is decoupled from a rotational movement of the shaft.

The device can be combined with the aspects of the device described above.

According to another independent aspect of the present disclosure, a device for drawing a liner into a tube by means of an inversion method is indicated. The device comprises a pressure vessel, which can be subjected to a pressure to invert the liner; and a shaft, which is rotatably supported in an interior of the pressure vessel and comprises a rotatably supported end and a free end, wherein the shaft is designed to unroll the liner for inversion.

According to another aspect, the pressure vessel has an inspection window in one region. The inspection window can be opened, for example, during the winding on of the liner before the be-ginning of the inversion process in order to control the winding of the liner onto the shaft and to align the liner on the shaft, e.g. manually. The liner can also be guided through the inspection window.

The device can be combined with the aspects of the devices described above.

According to another independent aspect of the present disclosure, a system for drawing a liner in an inverted manner into a tube is indicated, comprising: a device as described above, a liner, which can be coupled to the outlet opening of the device; and a curing device, which can be inserted via the supply access into the pressure vessel and the liner and is designed to emit radiation to cure the liner, wherein the device is designed to enable the at least one curing device to be connected to the first end of the liner in the interior of the pressure vessel before a beginning of the inversion.

The system can comprise a control unit, and the device can be connected to a control unit.

The control unit can monitor the pressure supply into the pressure vessel. For this purpose, there may be a pressure sensor in the pressure vessel. The pressure vessel can have a safety valve in order to prevent bursting of the liner in the event of excessive pressure.

The control unit can furthermore control the power supply to the curing head and/or temperature monitoring. The control unit can have an indication unit in order to indicate various parameters of the device, e.g. pressure, temperature of the curing head, power consumption of the curing head, and images from the at least one camera.

In addition, a winding device can be provided, which releases or pays out the supply line as the curing head is drawn into the liner and winds the supply line up again as the curing head is drawn back.

According to another independent aspect of the present disclosure, a method for drawing a liner into a tube by means of the device described in this document is indicated. The method comprises connecting the at least one curing device to the first end of the liner; subjecting the pressure vessel to a pressure in order to draw the liner into the tube with an inverting action, starting from a second end of the liner, wherein the at least one curing device is drawn into the tube together with the first end of the liner; releasing the at least one curing device from the first end of the liner after the liner has been drawn fully into the tube; and drawing the at least one curing device out of the tube while emitting energy to cure the liner.

The method for drawing a liner into a tube can implement the aspects described with reference to the device for drawing a liner into a tube by means of an inversion method.

According to the invention, the shaft from which the liner is unrolled during the inversion process is supported at one end. Moreover, the limiting element at the free end is decoupled from the rotational movement of the shaft. This makes it possible to ensure that a supply line for the curing device inserted through the supply access does not interfere with the unrolling mechanism of the liner. The curing device can thus be connected to the first or closed end of the liner even before the beginning of the inversion process. As a result, the inversion process can be carried out without interruption. In particular, it is not necessary to interrupt the inversion process after the halfway point in order to connect the curing device to the first or closed end of the liner. Moreover, a lock for connecting the curing device after the halfway point of the inversion process can be omitted, thereby making it possible to reduce the size of the device.

### BRIEF DESCRIPTION OF THE DRAWINGS

Exemplary embodiments of the disclosure are illustrated in the figures and are described in greater detail below. In the drawings:

FIG. 1 schematically shows a liner and a curing head being drawn into a tube,

FIG. 2 schematically shows the curing head being drawn out of the tube in order to cure the liner,

FIG. 3 schematically shows a section through a device for drawing a liner into a tube by means of an inversion method according to embodiments of the present disclosure,

FIG. 4 schematically shows another view of the device for drawing a liner into a tube in FIG. 3, and

FIG. 5 shows a flow diagram of a method for drawing a liner into a tube by means of an inversion method according to embodiments of the present disclosure,

FIG. 6 schematically shows a section through a device for drawing in a liner with a liner and a curing device,

FIG. 7 shows a section through an alternative device for drawing in a liner.

### EMBODIMENTS OF THE DISCLOSURE

Unless otherwise indicated, the same reference signs are used below for elements which are identical and have the same effect.

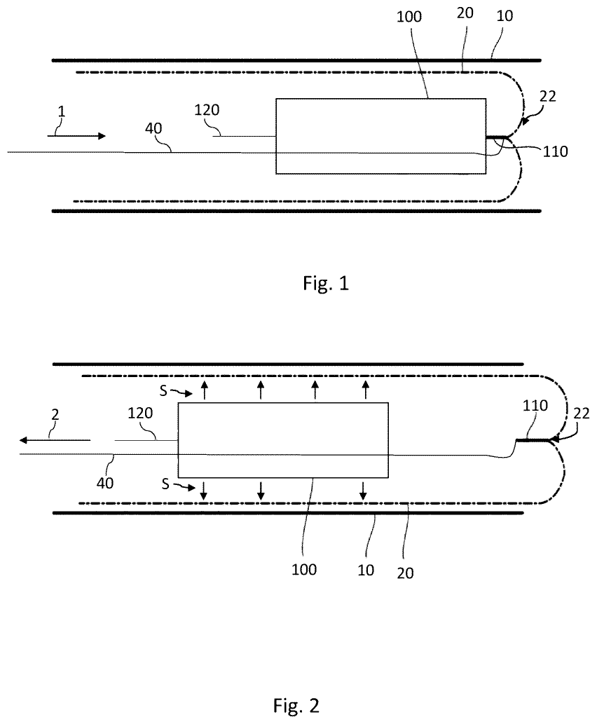

FIGS. 1 and 2 schematically show an inversion method for a liner 20. In particular, FIG. 1 schematically shows a liner 20 and a curing head 100 being drawn into a tube 10, and FIG. 2 schematically shows the curing head 100 being drawn out of the tube 10 in order to cure the previously drawn-in liner 20 during this process.

Inversion methods can be used to repair and/or reinforce a tube 10 using a liner 20. The liner 20 can consist of a flexible material, e.g. corrosion-resistant synthetic and/or glass fibers.

In detail, the liner 20 can have an inner side impregnated with a curable material. In some embodiments, the curable material can be a resin. The liner 20 can be drawn into the tube 10 in a draw-in direction 1 or can be forced into the tube 10 by means of the pressure, as shown in FIG. 1, such that the inner side impregnated with the curable material is inverted outward and comes to rest on the inner wall of the tube 10. For this purpose, it is possible, for example, to introduce air or water into the interior of the liner 20, as a result of which the liner 20 comes to rest progressively on the inner wall of the tube 10. To subject the interior of the liner 20 to pressure, one end of the liner 20 can be secured on an air or water supply device (not shown). The other end 22 of the liner 20, which is drawn into the tube 10, is closed, e.g. with a knot, a closure or a cap. The closed end 22 moves into the tube 20 during the progressive inversion of the liner 20.

After the liner 20 has been drawn in, the curable material of the liner 20 can be cured with heat and/or UV light S to ensure that the liner 20 is connected firmly to the tube 10. For this purpose, a curing head 100, which is connected to the closed end 22 of the liner 20 for example via a flexible connecting element 110, e.g. a short cord, can be drawn into the tube 10 together with the liner 20. After the liner 20 and the curing head 100 have been drawn into the tube 10, the connection between the curing head 100 and the liner 20 can be released. For this purpose, an electric signal can be supplied, e.g. via the supply line 120, in order to deactivate an electromagnet at the front end of the curing head 100. The flexible connecting element 110 can likewise be pneumatically decoupled or released from the front end of the curing head 100. As illustrated in FIG. 2, the curing head 100 can then be drawn back to the inlet of the tube 10 in a draw-out direction 2, which is counter to the draw-in direction 1, by means of a supply line 120 while emitting S heat and/or light in order to cure the curable material. The required voltage can be fed to the curing head 100 via the pulling cable or the supply line 120. In addition, compressed air can be fed in via the supply line 120 in order to cool the curing head 100.

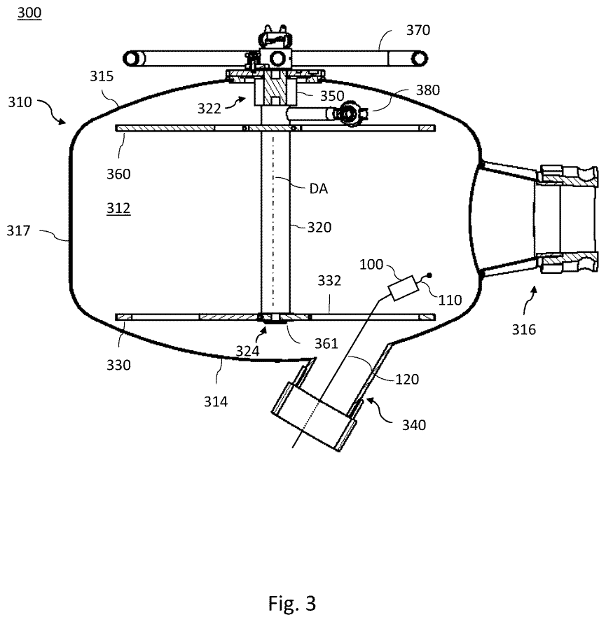

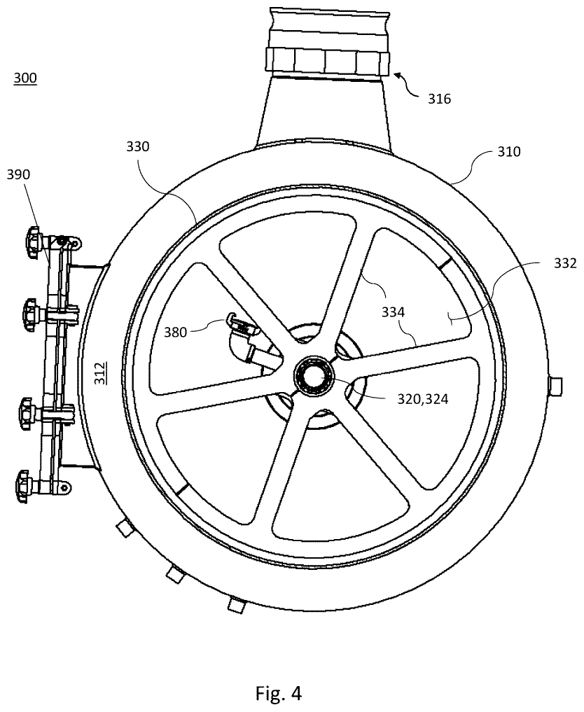

FIG. 3 schematically shows a section through a device 300 for drawing a liner into a tube by means of an inversion method according to embodiments of the present disclosure. FIG. 4 schematically shows another view of the device 300 for drawing a liner into a tube in FIG. 3.

The device 300 comprises a pressure vessel 310, which can be subjected to a pressure to invert the liner (not shown). The pressure vessel 310 can also be designed as a drum, preferably a cylindrical drum. The pressure vessel 310 has a first lateral vessel wall 314, a second vessel wall 315 opposite the latter, and a circumferential surface 317.

During this process, the liner 20 emerges from an outlet opening 316 of the pressure vessel 310, which opening lies opposite the tube. The outlet opening 316 is arranged on the circumferential surface of the drum. The liner 20 is secured on the outlet opening 316 and is thus inverted through the outlet opening 316 into the tube.

The device 300 furthermore comprises a shaft 320, which is rotatably supported in an interior 312 of the pressure vessel 310 and comprises a rotatably supported end 322 and a free end 324, wherein the shaft 320 is designed to unroll the liner 20 for inversion. In this case, the shaft 320 is transverse with respect to the outlet opening 316.

The device 300 furthermore comprises a first limiting element 330, which is arranged on the free end 324 of the shaft 320 and is decoupled from a rotational movement of the shaft 320. The first limiting element 330 is designed to limit a movement of the liner 20 in a direction parallel to an axis of rotation DA of the shaft 320. This prevents the liner 20 from slipping as it unrolls from the shaft 320.

The pressure vessel 310 comprises a vessel wall 314 with a supply access 340 for at least one curing device 100, which can be connected to a first end of the liner 20. The supply access 340 is arranged in a region of the vessel wall 314 which lies opposite the free end 324 of the shaft 320, or the vessel wall 314 with the supply access 340 is situated on the side of the pressure vessel 310 on which the first limiting element 330 is arranged in a freely rotating manner on the shaft 320. Between the free end 324 of the shaft 320 and the vessel wall 314 there is sufficient clearance to guide the flexible connecting element 110 past the shaft 320 and the first limiting element 330. In this case, the shaft does not extend over the entire width of the pressure vessel 310. That is to say that the pressure vessel 310 is wider in the region of the shaft 320 (parallel to the axis of rotation) than at the circumferential surface thereof.

In this case, the supply access 340 arranged laterally on the pressure vessel 310 is arranged as close as possible to the shaft 320 in order to require as little movement as possible for the flexible connecting element 110. On the other hand, however, good access for the curing device 100 to the outlet opening 316 should also be ensured. Thus, the supply line 120 and the curing head 100 can be guided to the outlet opening 316 without kinks and with as little friction as possible.

In this case, the at least one curing device 100 can be or is connected to the first end (closed end) of the liner in the interior 312 of the pressure vessel 310 even before a beginning of the inversion.

In addition, the first limiting element 330 is decoupled from the rotational movement of the shaft 320 in order to prevent a flexible connecting element 110 (e.g. a cord), which connects the at least one curing device 100 to the first end of the liner 20, from being wound onto the shaft 320 and/or with or on the first limiting element 330. In other words, the structure of the device 300 avoids a situation where the curing device 100, the supply thereof etc. interferes with the unrolling mechanism of the liner. That is to say that the curing device 100 can be connected or coupled to the first end of the liner 20 even before the closing of the pressure vessel 310. Thus, it is not necessary to relieve the pressure condition in the pressure vessel 310 in order to connect the already half blown-in liner 20 to the curing device 100.

The inversion process can therefore be carried out without interruption. In other words, the pressure vessel 310 can be subjected continuously to pressure from the beginning of the inversion to the end of the inversion. In particular, it is not necessary to interrupt the inversion process after the halfway point in order to connect the curing device 100 to the first or closed end of the liner 20. Moreover, a lock for connecting the curing device 100 after the halfway point of the inversion process can be omitted, thereby making it possible to reduce the size of the device 300.

In some embodiments, the supply access 340 in the vessel wall 340 has a seal 341, through which the supply line 120 is passed in order to pass through a power supply and/or compressed air/cooling air for the at least one curing device 100. The seal prevents unwanted escape of air from the closed system. In particular, the supply line 120 can be passed through the supply access 340 in order to supply the at least one curing device 100 with energy and/or compressed air from an external power source (not shown).

The shaft 320 comprises the rotatably supported end 322 and the free end 324. In other words, the shaft 320 is supported at one end. The end 322 of the shaft 320 can be rotatably supported by a rotary bearing 350, in particular on the pressure vessel 310 or vessel wall 314. The region of the vessel wall 314 on which the shaft 320 is rotatably supported and the region of the vessel wall 314 on which the supply access 340 is arranged can be opposite sides or opposite regions of the pressure vessel 310. In this case, the supply access 340 is arranged between the center of rotation or axis of rotation of the shaft of the pressure vessel 310 and the outlet opening 316. It can be aligned in the direction of the outlet opening 316 or obliquely to the axis of rotation of the shaft 320 in order to make it easier to feed the curing device 100 to the outlet opening 316. In this case, the opening of the supply access 340 is larger than the diameter of the shaft. The opening preferably does not overlap with the diameter of the shaft but is arranged close to the shaft.

As an option, the device 300 comprises a hand wheel 370 outside the pressure vessel 310. The hand wheel 370 can be connected to the shaft 320 and enables manually controlled winding-up and inversion (unwinding) of the liner through the outlet opening 316.

The first limiting element 330 is secured in a freely rotating manner on the free end 324 of the shaft 320. For example, the first limiting element 330 can be supported on the free end 324 of the shaft 320 by means of a rotary bearing 361, thus ensuring that the first limiting element 330 is decoupled from the rotational movement of the shaft 320.

In some embodiments, the first limiting element 330 comprises at least one aperture 332, through which the at least one curing device 100 can be guided in order to be drawn into the tube with the end of the liner 20. The flexible connecting element 110 for connecting the curing device 100 to the closed end of the liner 20 can also be guided through the at least one aperture 332.

In particular, the at least one supply line 120 can extend through the aperture 332 during the inversion process. Since the first limiting element 330 is decoupled from the rotational movement of the shaft 320, the first limiting element 330 can remain stationary while the curing device 100 is being drawn into the tube, thus enabling the inversion process to be continued without impairment. In this case, the aperture 332 is aligned with the outlet opening 316 in such a way that the curing device 100 can be drawn in as freely as possible to the outlet opening 316 and then into the liner 20. The curing device 100, in particular the curing head 100 and the supply line 120, can be introduced into the liner with as few bends as possible.

In this case, the aperture 332 can be a hole or a passage in the first limiting element 330. For example, the first limiting element 330 can be a wheel, and the aperture 332 can be present between two spokes 334 of the wheel. In other words, the at least one supply line 120 of the curing device 100 can extend through between the two spokes 334 during the liner inversion process.

In some embodiments, the device 300 further comprises a second limiting element 360, which is arranged on the supported end 322 of the shaft 320, wherein the second limiting element 360 is designed to limit a movement of the liner 20 in a direction parallel to the axis of rotation DA of the shaft 320. The second limiting element 360 is thus arranged between the hand wheel 370 and the first limiting element 330. Arranged between the first limiting element 320 and the second limiting element 360 is the region of the shaft onto which the liner 20 is wound and from which the liner 20 is unwound as it is blown in. The diameter of the cylindrical pressure vessel 310 can be larger than the width of the shaft 320 between the first and second limiting elements 330, 360.

In particular, the first limiting element 330 and the second limiting element 360 can be spaced apart from one another, wherein the shaft 320 extends from the first limiting element 330 to the second limiting element 360. In the space thus provided between the first limiting element 330 and the second limiting element 360, the liner 20 can be wound onto the shaft 320 before the beginning of the inversion process and can be unrolled from the shaft 320 during the inversion process in order to be drawn into the tube through the outlet opening 316 and inverted. In order to wind the liner 20 onto the shaft 320, the liner 20 is preferably guided through the outlet opening 316 or the inspection window 390. Since the closed end of the liner 20 is wound onto the shaft 320 first, the closed end is connected immediately to the head of the curing device 100. By virtue of the freely rotatable end, the flexible connecting element 110 between the curing device 100 and the closed end is not wound on.

In some embodiments, the second limiting element 360 can be connected rigidly to the shaft 320. In other words, the second limiting element 360 can be coupled to the rotational movement of the shaft 320 and rotate along with the shaft 320 during the unrolling of the liner.

In some embodiments, the second limiting element 360 comprises (or is) a disk and/or a wheel. In particular, the second limiting element 360 can be a limiting disk.

The shaft 320, the first limiting element 330 and the second limiting element 360 preferably form a drum reel. The first limiting element 330 and the second limiting element 360 can be of similar construction and differ in respect of rotatability relative to the shaft 320.

As an option, the device 300 can further comprise an inlet 380. Through the inlet 380, water, in particular warm water, for curing epoxy resin can be introduced into the liner. In addition, the device can have a valve (not illustrated), via which pressure can be released in a controlled manner. This is necessary, for example, once the liner has been blown fully into the tube. The curing head 100 is then drawn back and activated in order to cure the resin of the liner by supplying light or heat. During this process, the curing head 100 becomes very hot and must be cooled. This cooling is accomplished by supplying air or compressed air via the supply line 120. Before the curing head 100 is drawn back, the application of pressure to the liner is reduced or stopped. The cooling air fed in via the supply line 120 thus represents an additional air supply, although the volume in the tube no longer changes. This additional air can be released in a controlled manner via the valve (not illustrated) in order to prevent the liner from bursting or being damaged.

In addition, the pressure vessel 310 can have an inspection window 390 in its outer circumference to enable the interior of the pressure vessel 310 to be viewed and the unwinding process of the liner 20 to be monitored or the winding process to be corrected with the inspection window 390 open.

The first limiting element 330 and the second limiting element 360 within the pressure vessel 310 serve to control the winding or unwinding of the liner on and off the shaft and to ensure that the liner 20 remains on the shaft 320 during winding or unwinding.

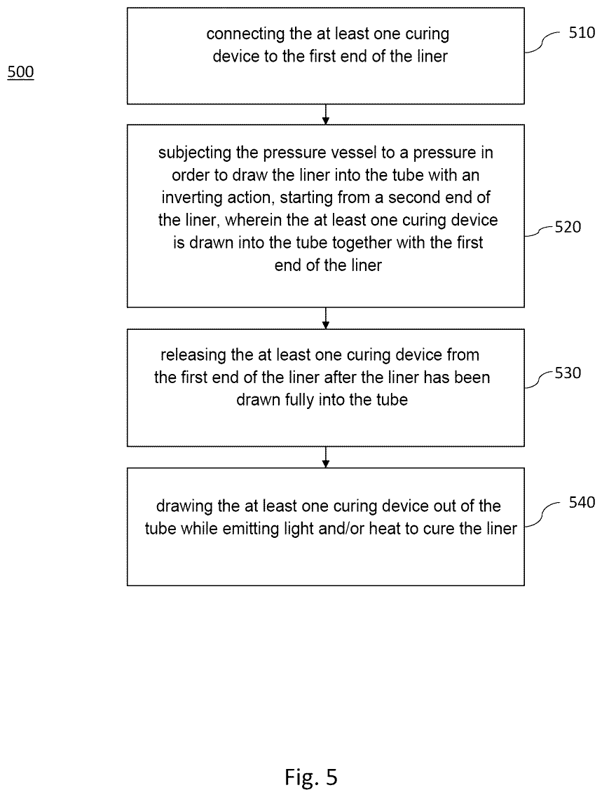

FIG. 5 shows a flow diagram of a method 500 for drawing a liner into a tube according to embodiments of the present disclosure. The method 500 uses the device for drawing a liner into a tube by means of an inversion method of the present disclosure.

In block 510, the method 500 comprises connecting the at least one curing device 100 to the first end of the liner; in block 520, subjecting the pressure vessel 310 to a pressure in order to draw the liner 20 into the tube with an inverting action, starting from a second end of the liner 20, wherein the at least one curing device 100 is drawn into the tube together with the first end of the liner 20; in block 530, releasing the at least one curing device 100 from the first end of the liner 20 after the liner 20 has been drawn fully into the tube; and, in block 540, drawing the at least one curing device 100 out of the tube while emitting energy to cure the liner.

According to the invention, the shaft 320 from which the liner 20 is unrolled during the inversion process is supported at one end. Moreover, the limiting element 330 at the free end is decoupled from the rotational movement of the shaft 320. This makes it possible to ensure that a supply line 120 for the curing device 100 inserted through the supply access 340 does not interfere with the unrolling mechanism of the liner. The curing device 100 can thus be connected to the first or closed end of the liner 20 even before the beginning of the inversion process. As a result, the inversion process can be carried out without interruption, i.e. without pressure interruption. In particular, it is not necessary to interrupt the inversion process after the halfway point in order to connect the curing device 100 to the first or closed end of the liner 20. Moreover, a lock for connecting the curing device 100 after the halfway point of the inversion process can be omitted, thereby making it possible to reduce the size of the device.

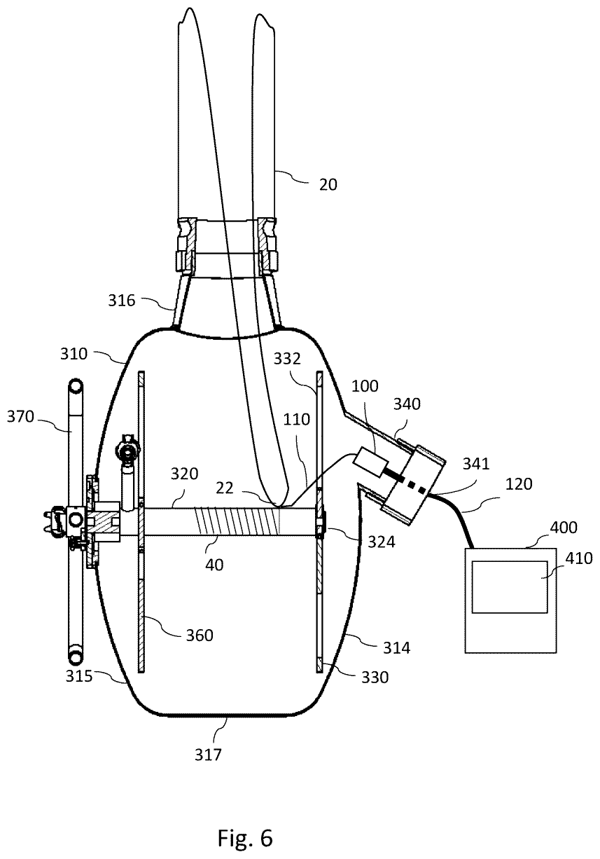

A description is given below of how the device 300 for drawing in a liner 20 is prepared. On the shaft 320 there is a holding cord 40, which serves to control the progress or movement of the liner 20 into the tube 10 during the inversion process. If the liner 20 is blown into the tube 10 by the pressure application, uniform blowing-in or inversion of the liner into the tube can be ensured by means of the holding cord 40. For this purpose, the hand wheel 370 on the pressure vessel 310 is turned slowly in order to prevent the liner from being blown jerkily into the tube. The holding cord 40 is connected to the closed end of the liner 20. Before the liner 20 is wound onto the shaft 320, the flexible connecting element 110, which is coupled to the curing device 100, is connected to the closed end of the liner 20. The flexible connecting element 110 can be coupled to the curing device 100 by means of an electromagnet, for example. This electromagnet is activated, and the flexible connecting element 110 is thus connected to the curing device 100 or curing head 100. The liner 20 is then wound onto the shaft 320, preferably through the outlet opening 316 or the inspection window 390. In this case, the flexible connecting element 110 secured on the curing head 100 merely twists, like a plug in the case of a cable drum. Owing to the freely rotating limiting element 330, the flexible connecting element 110 is not wound onto the shaft 320 or does not become entangled with the limiting element 330. The liner 20 is wound onto the shaft 320 until there is only a short piece of the liner 20 protruding from the outlet opening 316. For this purpose, the hand wheel 370 is preferably rotated counter to the draw-in direction. The protruding or projecting end of the liner 20 is inverted around an edge of the outlet opening 316 and fixed there, e.g. by clips or clamps/pipe clamps/hose clamps, cable ties etc., which fix the liner on the edge of the outlet opening 316. The outlet opening 316 is then aligned with the tube, and the blowing-in or inversion process is started by pressure application by the control unit 400 illustrated in FIG. 6. Before the pressure vessel 310 is subjected to pressure, the supply access 340 is closed. The pressure vessel 310 is thus tightly closed and, when pressure is applied, the liner 20 can then only emerge from the outlet opening 316 in the tube 10. During this process, it is inverted. The longer the pressure lasts, the further the liner 20 moves into the tube. The uniform progression of the liner into the tube is controlled via the holding cord 40, which is wound onto the shaft 320 and is connected to the closed end of the liner 20, or by turning the hand wheel 370. After the liner has been unwound from the shaft 320, i.e. when the closed end of the liner with the coupled flexible connecting element 110 and the curing device 100 coupled thereto is drawn in the direction of the outlet opening 316, the first freely rotating limiting element 330 ceases to rotate, and the curing device 100 can be drawn through the aperture 332 into the tube or into the liner 20 within the tube. The liner then moves with the curing device 100 further into the tube. This is continued until the closed end of the liner has arrived at the remote end in the tube. The pressure within the liner is about 0.45 bar. Via an unlocking mechanism, the flexible connecting element 110 is then decoupled from the curing device 100, and the curing device 100 is activated and drawn out of the tube. The flexible connecting element 110 remains on the remote end of the tube. As the curing head is drawn back, it is activated, with the result that the resin of the liner is cured by means of emitted light or heat. The curing device 100 can be connected to the pulling cable or the supply line 120. This can also ensure the power supply and/or cooling air supply for the curing device 100.

In FIG. 6, the pressure vessel 310 is shown in a manner similar to FIG. 3, wherein in this case the liner 20 and the curing device 100 are illustrated with the flexible connecting element 110 and the supply line 120. The supply line 120 is connected to the control unit 400, which contains an indication unit 410, on which the parameters of the inversion process are displayed. The holding cord 40 is illustrated on the shaft 320, said cord being connected to the closed end 22 of the liner 20. The flexible connecting element 110 is also connected to the closed end 22 of the liner 20. FIG. 6 shows a state in which the liner 20 is fixed on the outlet opening 316. When the system is then subjected to further pressure, the liner 20 is blown further into the tube (not illustrated). During this process, it takes along the curing head 100 and the supply line 120 connected thereto into the tube 10. The holding cord 40 is then also drawn along into the tube and can be guided by means of the hand wheel 370 until the closed end 22 of the liner 20 arrives at the end of the tube or until the maximum liner length is reached.

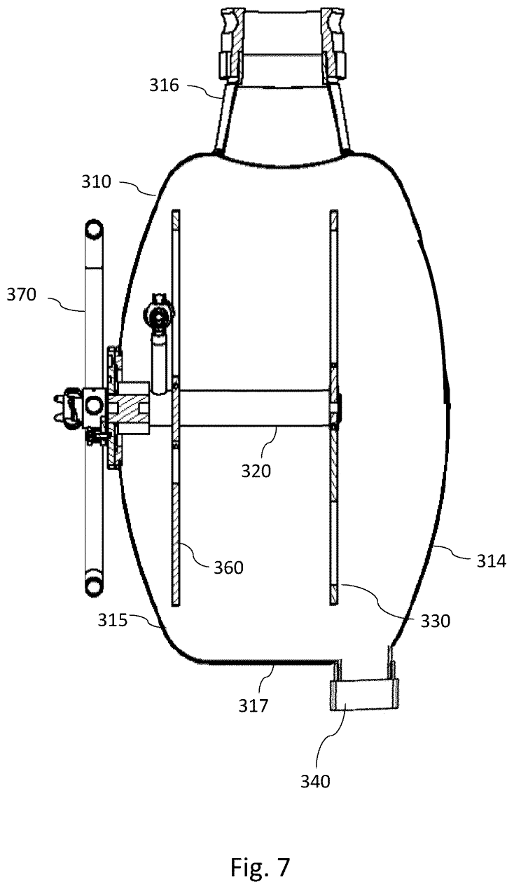

FIG. 7 shows an alternative device for drawing in a liner. In this case, the supply access 340 is arranged in the circumferential surface 317 of the pressure vessel 310. The supply access 340 for the curing device 100 is situated in a region of the circumferential surface 317 of the pressure vessel 310 which overlaps with the free region outside the shaft 320 and overlaps only insignificantly or not at all with the shaft 320. This ensures that the curing head 100 with the coupled connecting element 110 can be coupled to the liner 20 or the closed end 22 of the liner 20 through the first limiting element 330. Since the first limiting element 330 does not rotate with the shaft 320 and is decoupled from the latter, the connecting element 110 does not wind onto the shaft 320.

Although the invention has been illustrated and explained more specifically in detail by means of preferred exemplary embodiments, the invention is not limited by the examples disclosed, and other versions can be derived therefrom by a person skilled in the art without exceeding the scope of protection of the invention. It is therefore clear that there is a large number of possible versions. It is likewise clear that embodiments mentioned by way of example in fact represent only examples, which should not be interpreted in any way as limiting the scope of protection, the possible uses or the configuration of the invention, for example. On the contrary, the preceding description and the description of the figures put a person skilled in the art in a position to implement the illustrative embodiments in a concrete way, wherein, given a knowledge of the inventive concept disclosed, a person skilled in the art can make various modifications, e.g. in respect of the functioning or arrangement of individual elements mentioned in an illustrative embodiment, without exceeding the scope of protection defined by the claims and legal equivalents thereof, such as further reaching explanations in the description.

1-13. (canceled)

14. A device for drawing a liner into a tube by means of an inversion method, comprising:
a pressure vessel, which can be subjected to a pressure to invert the liner;
a shaft, which is rotatably supported in an interior of the pressure vessel and comprises a rotatably supported end and a free end, wherein the shaft is designed to unroll the liner for inversion; and
a first limiting element, which is arranged at the free end of the shaft and is decoupled from a rotational movement of the shaft, wherein the first limiting element is designed to limit a movement of the liner in a direction parallel to an axis of rotation of the shaft,
wherein the pressure vessel comprises a supply access for at least one curing device, which can be connected to a first end of the liner.

15. The device as claimed in claim 14, wherein the supply access is arranged in a vessel wall of the pressure vessel which lies opposite the free end of the shaft, or is arranged in a circumferential surface of the pressure vessel.

16. The device as claimed in claim 14, wherein the device is designed to subject the pressure vessel continuously to the pressure from a beginning of the inversion to an end of the inversion.

17. The device as claimed in claim 14, wherein the supply access is designed to allow a power and/or pressure supply for the at least one curing device to pass through in a sealing manner.

18. The device as claimed in claim 14, wherein the first limiting element is secured in a freely rotating manner on the free end of the shaft.

19. The device as claimed in claim 14, wherein the first limiting element is supported on the free end of the shaft by means of a rotary bearing.

20. The device as claimed in claim 14, wherein the first limiting element comprises a disk with at least one aperture, through which the at least one curing device can be guided in order to be drawn into the tube with the first end of the liner.

21. The device as claimed in claim 14, wherein the length of the shaft is shorter than a width of the pressure vessel in the region of the axis of rotation of the shaft.

22. The device as claimed in claim 14, further comprising a second limiting element, which is arranged on the supported end of the shaft, wherein the second limiting element is designed to limit a movement of the liner in a direction parallel to the axis of rotation of the shaft.

23. The device as claimed in claim 22, wherein the shaft, the first limiting element and the second limiting element form a drum reel.

24. A system for drawing a liner in an inverted manner into a tube, comprising:
the device as claimed in claim 14,
the liner, which can be coupled to the outlet opening of the device; and
a curing device, which can be inserted via the supply access into the pressure vessel and the liner and is designed to emit radiation to cure the liner,
wherein the device is designed to enable the at least one curing device to be connected to the first end of the liner in the interior of the pressure vessel before a beginning of the inversion.

25. The system as claimed in claim 24, wherein the first limiting element is decoupled from the rotational movement of the shaft in order to prevent a flexible connecting element, which connects the at least one curing device to the first end of the liner, from being wound onto the shaft and/or the first limiting element, in particular wherein the flexible connecting element is a cord.

26. A method for drawing a liner into a tube by means of the device as claimed in claim 14 and of a curing device, comprising the following steps:
connecting the at least one curing device to the first end of the liner;
subjecting the pressure vessel to a pressure in order to draw the liner into the tube with an inverting action, starting from a second end of the liner, wherein the at least one curing device is drawn into the tube together with the first end of the liner;
releasing the at least one curing device from the first end of the liner after the liner has been drawn fully into the tube; and
drawing the at least one curing device out of the tube while emitting light and/or heat to cure the liner.
